(19) United States
(12) Patent Application Publication
(10) Pub. No.: US 2012/0078674 A1
(43) Pub. Date: Mar. 29, 2012

(54) METHOD AND SYSTEM FOR END-TO-END PROCESS EXECUTION

(75) Inventors: Sukriti Goel, Bangalore (IN); Jyoti M. Bhat, Bangalore (IN)

(73) Assignee: INFOSYS TECHNOLOGIES LIMITED, Bangalore (IN)

(21) Appl. No.: 13/070,717

(22) Filed: Mar. 24, 2011

(30) Foreign Application Priority Data
Sep. 27, 2010 (IN) 2824/CHE/2010

(51) Int. Cl. G06Q 10/06

(52) U.S. Cl. 705/7.15

(57) ABSTRACT

The present invention provides a method and system for end-to-end process execution. The method includes generating a model for a business process to be executed, wherein the business process comprises a first type of activity and a second type of activity. On initiation of a business process instance of the business process, the first type of activity is executed by a business process engine. Further, the second type of activity is dynamically assigned to a first user for execution on an application external to the business process engine based on a set of predefined factors, provided the second type of activity is a manual activity. The method further includes monitoring execution of the second type of activity by the business process engine and displaying status of each activity in the business process instance to a second user.

### BACKGROUND OF THE INVENTION

The invention relates generally to the field of business process management. In particular, the invention relates to a method and system for providing end-to-end process execution of business processes across multiple heterogeneous systems.

Organizations invest heavily in information technology (IT) infrastructure, such as legacy systems, packages, products, and so forth, that delivers most of the required business functionality. The effort is always to reuse previously built functionality while building capabilities to meet the constantly changing business requirements. Various techniques are adopted for leveraging the existing functionality while increasing the flexibility of the legacy systems, such as implementing a business process management system (BPMS) or a workflow system, process monitoring, mashups, service orientation of systems, and the like. Almost all these approaches need a considerable amount of time and investment in writing new code, creating wrappers for service enablement, coding new user interface (UI), adding probes, making design changes in the existing application, and so forth. These are strategic decisions that need buy-in and commitment for various stakeholders.

However, business users have many operational requirements that call for quick turnaround times for IT changes, with minimal disturbance to the current process execution. These changes are required to increase business user productivity and they involve certain IT related modifications. These modifications usually include, but are not limited to, adding, removing, and modifying activities in the business process related to approvals, information capture, alerts, and allocation rules. These operational requirements relate to human intervention in the business process and increased visibility into the process execution data in systems. The business user requirements need to be provided as capabilities added on top of the existing system functionalities without involving huge investments and involving other stakeholders.

Typically, end-to-end business processes execute across multiple heterogeneous systems with manual handoffs, multiple human interventions and batch uploads between systems. This creates delays in the process execution as the process instance progresses only when a user logs in and works on his tasks. A typical business user may be involved in multiple processes and has to periodically check various systems to identify and complete his different responsibilities. This affects business user productivity and process efficiency. Further, there is the additional constraint on process visibility since process instance level monitoring is not possible owing to the process flow not being explicit in process unaware systems.

Thus, in light of the foregoing discussion, there is a need for a method and a system that will provide required BPMS capabilities over existing systems with minimum changes to current processes and systems. The method and system should also enable end-to-end business process execution across multiple heterogeneous systems.

### BRIEF SUMMARY OF THE INVENTION

The present invention relates to a method for providing end-to-end process execution. The method includes generating a model for a business process to be executed, wherein the business process comprises a first type of activity and a second type of activity. On initiation of a business process instance of the business process, the first type of activity is executed by a business process engine, whereas the second type of activity is dynamically assigned to a first user for execution on an application external to the business process engine based on a set of predefined factors, provided the second type of activity is a manual activity. The method further includes monitoring execution of the second type of activity on the external application by the business process engine and displaying status of each activity in the business process instance to a second user.

The present invention relates to a system for providing end-to-end process execution. The system includes a process modeler configured to generate a model for a business process to be executed, wherein the business process comprises a first type of activity and a second type of activity. The system further includes a business process engine configured to execute the first type of activity on initiation of a business process instance. The business process engine assigns the second type of activity dynamically to a first user for execution on an application external to the business process engine based on a set of predefined factors, provided the second type of activity is a manual activity. Additionally, the business process engine monitors execution of the second type of activity. The system further includes a dashboard configured to display status of each activity in the business process instance to a second user.

### BRIEF DESCRIPTION OF THE DRAWINGS

These and other features, aspects, and advantages of the present invention will be better understood when the following detailed description is read with reference to the accompanying drawings in which like characters represent like parts throughout the drawings, wherein:

FIG. 1 shows an environment 100 in which the present invention can be practiced, in accordance with an embodiment of the present invention;

FIG. 2 shows an environment 200 in which the present invention can be practiced, in accordance with another embodiment of the present invention;

FIG. 3 is a flowchart describing a method for end-to-end process execution, in accordance with an embodiment of the present invention;

FIG. 4 and FIG. 5 are flowcharts describing a method for end-to-end process execution, in accordance with another embodiment of the present invention; and

FIG. 6 illustrates a generalized example of a computing environment 600.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

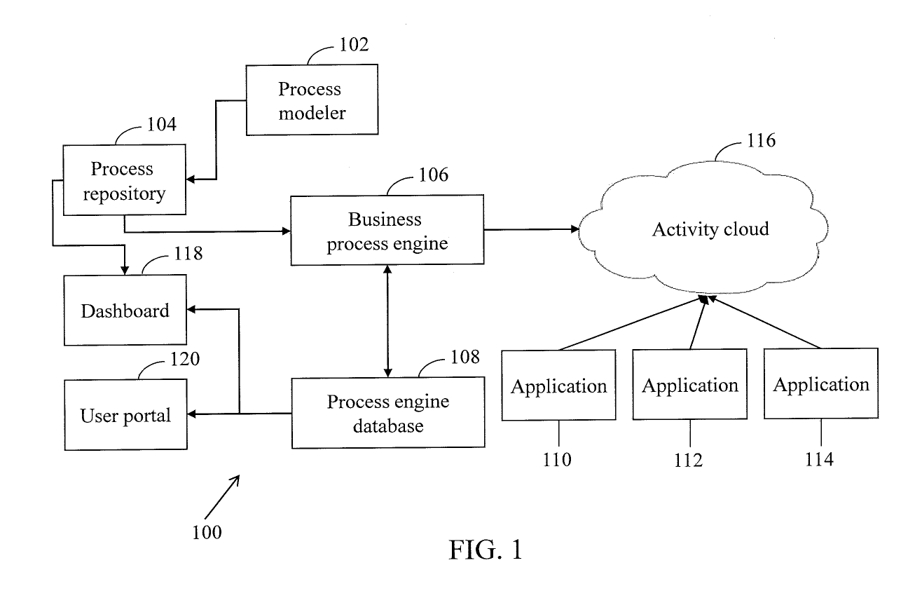

FIG. 1 is a block diagram of an environment 100 for end-to-end process execution, in accordance with an embodiment of the present invention. Environment 100 includes a process modeler 102, a process repository 104, a business process engine 106, a process engine database 108, a plurality of applications 110, 112 and 114, an activity cloud 116, a dashboard 118 and a user portal 120.

Process modeler 102 is used to model a business process that includes one or more activities for execution. The modeled business process is stored in process repository 104. Business process engine 106 accesses process repository 104 on initiation of a business process instance. If the activity is of a first type, business process engine 106 executes the activity. However, if the activity is of the second type, business process engine 106 monitors execution of the activity on an external application, such as any of applications 110, 112 and 114. Additionally, if the second type of activity is a manual activity, business process engine 106 assigns the activity dynamically to a first user (not shown in the figure) for execution on one of applications 110, 112 and 114. The first user may view the assigned activity on user portal 120. Process engine database 108 stores all details of the process instance, including information on the assignment of the activity to a particular user. Business process engine acquires execution status of the second type of activity from the external application executing the activity, through activity cloud 116. Subsequently, business process engine 106 correlates the activity to a list of monitored activities and a relevant process instance based on a correlation identifier of the activity and moves to the next activity in the process instance. Dashboard 118 displays the status of each activity to a second user.

In accordance with various embodiments of the present invention, process modeler 102 generates a business model of the business process to be executed. Examples of the business process include, but are not limited to, an order management process, inventory management process, payroll process, and a retail banking process. While generating the business model, process modeler 102 models one or more activities in the business process. According to one embodiment of the present invention, the business process that is to be executed may be modeled using modeling tools that support modeling of a business process having different types of activities. Details on the different types of activities have been provided in subsequent paragraphs. A person skilled in the art may be aware that there exist multiple technologies and solutions to model a business process. Overall, the business model includes the one or more activities, the type of each activity and a process flow containing the order of the activities.

Process repository 104 stores all information relevant to the business process, such as the process definition/flow created in process modeler 102. Once the process definition is deployed in process repository 104, the business process is available for execution.

Business process engine 106 accesses the business process deployed in process repository 104 on initiation of a process instance of the business process. In accordance with an embodiment of the present invention, business process engine 106 initiates the process instance on invocation of an application programming interface (API) of business process engine 106. In accordance with another embodiment, business process engine 106 initiates the process instance on receiving a ‘process start’ event. It will be apparent to a person skilled in the art that business process engine 106 may also initiate multiple process instances simultaneously.

In accordance with various embodiments of the present invention, the business process includes at least two types of activities. The first type of activity may be a system activity or a manual activity, wherein the system activity includes a web service activity, a Java activity, and the like. Similarly, the second type of activity may also be a system activity or a manual activity. It should be noted that the difference between the two types of activities is that the first type of activity is executed by business process engine 106, whereas the second type of activity is executed by an application external to business process engine 106, such as one of applications 110, 112 and 114. Accordingly, in the context of this invention, the first type of activity has been referred to as an orchestrated activity, since it is orchestrated by business process engine 106, whereas the second type of activity has been referred to as a monitored activity, since its execution is monitored by business process engine 106. Thus, as will be explained in the subsequent paragraphs, a part of the business process may be executed in business process engine 106 while another part may be executed in an application external to business process engine 106.

In accordance with an embodiment of the present invention, business process engine 106 assigns a correlation identifier to each monitored activity as at least one name-value pair. The correlation identifier ties an activity with the process instance that initiated it. As will be explained later, using the correlation identifier, business process engine 106 correlates each monitored activity to its corresponding process instance.

On initiation of a process instance, business process engine 106 checks the type of the first activity in the process instance. If the activity is an orchestrated activity, business process engine 106 executes the activity and updates the status of the activity accordingly. It should be noted that if the orchestrated activity is a manual activity, business process engine 106 may assign the activity to a first user dynamically. However, if the activity is a monitored activity, business process engine 106 further checks whether the monitored activity is a system activity or a manual activity. If the activity is a manual activity, business process engine 106 allocates the activity dynamically to the first user for execution on an external application. In accordance with an embodiment of the present invention, business process engine 106 allocates the monitored activity to the first user based on predefined factors that include, but are not limited to, workload of the first user, role of the first user, and time of day. Thus, if there are two users to whom an activity can be allocated, business process engine 106 may identify the workload of the users and allocate the activity to the user whose workload is less. In an embodiment, the predefined factors and the corresponding allocation rules may be stored in process repository 104 in the form of a rule-set defined by a process administrator.

Further, the role of the first user may also be considered during allocation of the activity. For example, if a particular activity is to be performed only by a user having the designation of a ‘manager’, the activity is made visible only in the inbox (or portal) of one or more ‘managers’ eligible to perform the activity. Thereafter, the user may decide which activity to perform from among a list of pending activities. The list of pending activities is displayed to users at their individual portals, such as user portal 120, and a user may claim the activity to himself. It may be understood that user portal 120 acquires information about pending activities for the user from process engine database 108, which stores all details of the process instance, including information on the assignment of the activity to a particular user. For example, if a user ABC takes up the activity, the status of the activity is accordingly updated as ‘allocated to ABC’ on user portal 120. The user may then execute the activity on one of the external applications 110, 112 and 114. The time of day may serve as an important factor for users who work in shifts. Depending on the time when the activity is to be performed, the availability of the users is checked and the activity is assigned to an appropriate user.

As the external application, such as application 110, executes the activity, business process engine 106 identifies one or more events by determining any change in the state of application data generated by application 110. Examples of changes in the application data include, but are not limited to, addition of a new row in a database table, updating a change of column in a database table, entries made to a log file, and so forth. Application 110 may be any legacy system capable of executing the second type of activity, such as a mainframe-based application. In accordance with an embodiment, business process engine 106 polls application data generated by application 110 at predefined intervals of time to identify the events. Subsequently, business process engine 106 relates each of the identified events with the process model based on a set of predefined mapping rules. It should be noted that the event may mark any of start of a process, end of the process, start of an activity and end of the activity. The set of predefined mapping rules take into consideration operation of the event, sender, or receiver of the event to map each of the identified events to the list of monitored activities. For example, when business process engine 106 receives a ‘process start’ event, a new process instance is created, or a process instance progresses to the next step when an ‘activity end’ event is identified.

In accordance with various embodiments, business process engine 106 maintains a list of activities that are pending for execution. The activities may include both orchestrated activities and monitored activities. Business process engine 106 may also maintain a queue of process instances that have been initiated. On receiving an ‘activity end’ event, business process engine 106 correlates the activity with a list of pending monitored activities and the relevant process instance, updates the status of the activity as ‘closed’ or ‘complete’ and moves to the next activity in the process instance.

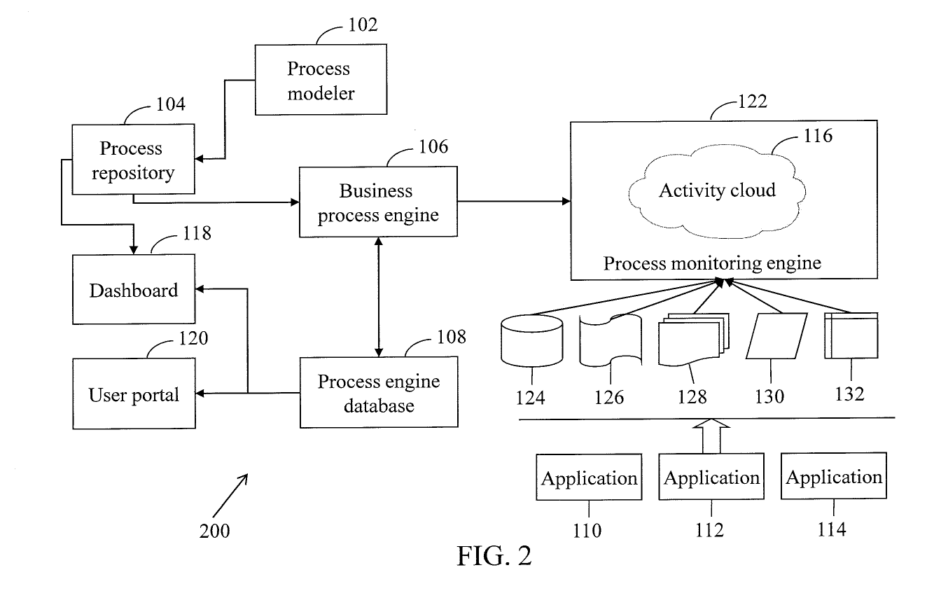

In accordance with an embodiment of the present invention, all the activities executed by the external applications are collected at activity cloud 116. As used herein, the activity cloud refers to a logical collection of activities that are not correlated. As explained earlier, these activities are subsequently correlated by business process engine 106 using the correlation identifier. In an embodiment, the activity cloud may exist in a process monitoring engine, as will be explained in conjunction with FIG. 2.

Dashboard 118 displays the status of each activity to a second user. The status of each activity may include any of ‘complete’, ‘in progress’, ‘pending’, and so forth. In accordance with an embodiment, the first user and the second user may be the same. In accordance with another embodiment, the second user may be the process administrator. Dashboard 118 may also generate alerts for activities in the business process that do not meet predefined key performance indicators (KPIs) and/or service level agreements (SLAs).

FIG. 2 is a block diagram of an environment 200 for end-to-end process execution, in accordance with another embodiment of the present invention. Environment 200 includes a process modeler 102, a process repository 104, a business process engine 106, a process engine database 108, a plurality of applications 110, 112 and 114, an activity cloud 116, a dashboard 118, a user portal 120 and a process monitoring engine 122. Further, environment 200 may also include a database 124, logs 126, files 128, message queues 130 and emails 132.

It should be noted that details of various components shown in the figure, namely, process modeler 102, process repository 104, business process engine 106, process engine database 108, plurality of applications 110, 112 and 114, activity cloud 116, dashboard 118, and user portal 120 have been described earlier in conjunction with FIG. 1 and hence, are not described again. Process monitoring engine 122 has been described in detail in the subsequent paragraphs.

As shown in the figure, process monitoring engine 122 includes activity cloud 116. Process monitoring engine 122 receives execution status of an activity from an external application executing the activity, such as application 110. That is, application 110 executes the activity and notifies process monitoring engine 122 regarding completion of the activity. In another embodiment, process monitoring engine 122 polls application data generated by application 110 at predefined intervals of time to identify various events. The application data may be present in any source such as database 124, logs 126, files 128, message queues 130 and emails 132. As explained in conjunction with FIG. 1, the events may be identified by any change in the state of the data, such as creation of a new row in a database table, an update in a column of the database table, entries in a log file, and so forth and mapped to one of ‘process start’, ‘activity start’ and ‘activity end’ events. On capturing an ‘activity end’ event of the activity from any of the above-mentioned sources, process monitoring engine 122 notifies business process engine 106 and provides the correlation identifier of the activity to business process engine 106. Business process engine 106 correlates the activity to the list of pending monitored activities and the relevant process instance using the correlation identifier and updates the status of the activity as ‘complete’. Business process engine 106 then moves to the next activity in the business process.

In accordance with an embodiment of the present invention, a process administrator may set various KPIs for activities in the business process that needs to be executed using a key performance indicator (KPI) modeler (not shown in the figure). The KPIs set by the KPI modeler may be used to generate alerts for activities in the business process that do not meet the set KPIs. The alerts may subsequently be delivered to the process administrator in various ways. These ways include e-mail, SMS, paging message, instant messages, call, or an alert on dashboard 118. Similarly, service level agreements (SLAs) may be defined for the activities and alerts may be generated on violation of a defined SLA.

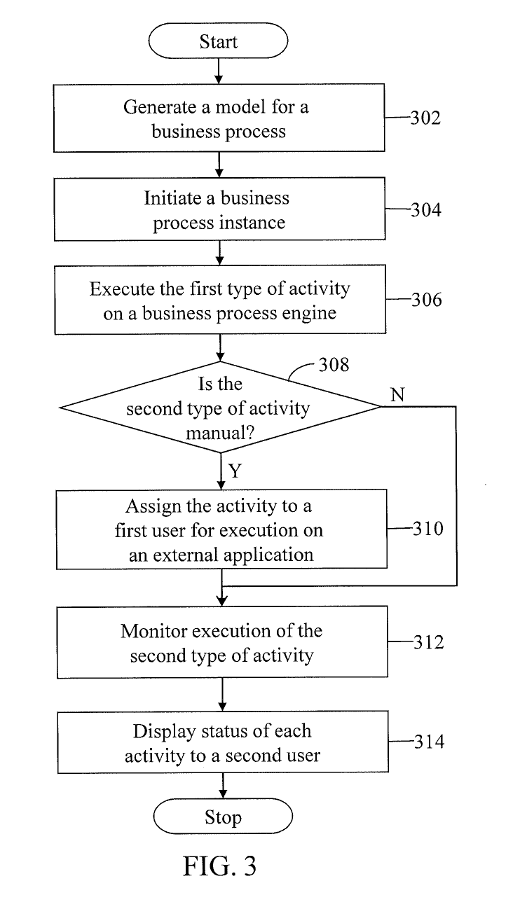

FIG. 3 is a flowchart describing a method for end-to-end process execution, in accordance with an embodiment of the present invention.

At step 302, a model for a business process is generated. The business process may include a first type of activity (orchestrated) and a second type of activity (monitored). The model may be generated using modeling tools that support modeling of a business process having both orchestrated and monitored activities.

At step 304, an instance of the business process is initiated by a business process engine. In accordance with an embodiment of the present invention, the business process engine initiates the process instance either on invocation of an application programming interface (API) of the business process engine or on receiving a ‘process start’ event.

At step 306, the business process engine executes the first type of activity, that is, an orchestrated activity, and updates the status of the activity accordingly. The first type of activity may be a system activity or a manual activity. In case the activity is a manual activity, the business process engine may assign the activity to a first user dynamically for execution on the business process engine based on predefined factors.

At step 308, the business process engine checks whether the second type of activity is a manual activity or a system activity. If the activity is a manual activity, the business process engine assigns the activity dynamically to the first user at step 310 for execution on an application external to the business process engine based on predefined factors. In accordance with an embodiment, the external application may be any legacy system capable of executing the second type of activity. Further, the predefined factors may include, but are not limited to, workload of the first user, role of the first user, and time of day. However, if the activity is a system activity, the business process engine does not assign the activity to any user and control flows to step 312.

At step 312, the business process engine monitors execution of the second type of activity. On receiving execution status of the activity from the external application executing the activity, the business process engine correlates the activity with a relevant process instance based on a correlation identifier and subsequently updates the status of the activity. In accordance with various embodiments, the business process engine may receive the execution status of the activity from either a process monitoring engine or from the external application executing the activity.

At step 314, the business process engine displays status of each activity to a second user on a dashboard. Activities that do not meet predefined SLAs and/or KPIs may be flagged and the user may be alerted through an e-mail, SMS, paging message, instant messages, call, or an alert on the dashboard.

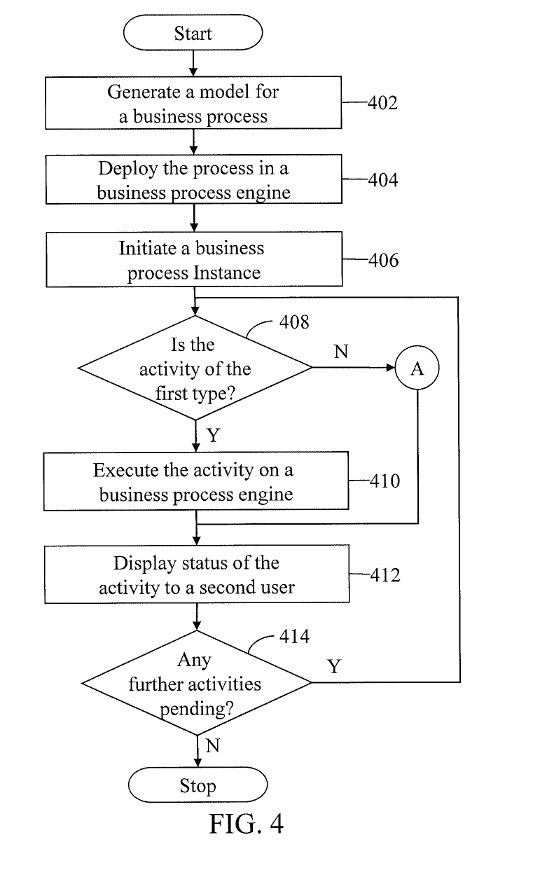

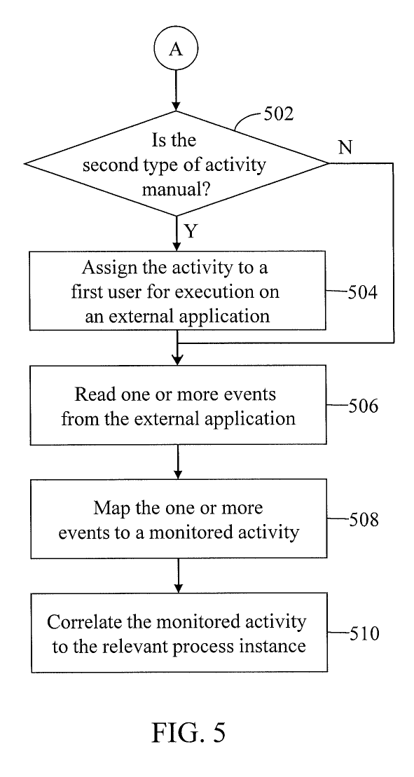

FIG. 4 and FIG. 5 are flowcharts describing a method for end-to-end process execution, in accordance with another embodiment of the present invention.

At step 402, a model for a business process is generated. The business process may include a first type of activity and a second type of activity. In accordance with an embodiment, the model is generated using modeling tools that support modeling of a business process having both orchestrated and monitored activities.

At step 404, the business process definition is deployed in a process repository. Further, the business process is made available for execution on a business process engine.

At step 406, the business process engine initiates an instance of the business process. In accordance with an embodiment of the present invention, the business process engine initiates the process instance either on invocation of an application programming interface (API) of the business process engine or on receiving a ‘process start’ event.

At step 408, the business process engine checks whether the activity to be executed is of the first type or the second type, that is, whether the activity is an orchestrated activity or a monitored activity. In an embodiment, the type of the activity is defined at the time of generating the model of the business process. If the activity is of the first type, that is, an orchestrated activity, the business process engine executes the activity at step 410. Further, if the orchestrated activity is a manual activity, the business process engine may assign the activity to a first user dynamically for execution on the business process engine based on predefined factors.

At step 412, the business process engine displays status of the activity to a second user on a dashboard. If the activity does not meet predefined SLAs and/or KPIs, the activity may be flagged and the user may be alerted through an e-mail, SMS, paging message, instant messages, call, or an alert on the dashboard.

However, if the activity is of the second type, that is, if the activity is a monitored activity, the business process engine further checks whether the monitored activity is a system activity or a manual activity, at step 502. If the activity is a manual activity, the business process engine assigns the activity dynamically to a first user at step 504 for execution on an application external to the business process engine, based on predefined factors. The predefined factors include, but are not limited to, workload of the first user, role of the first user, and time of day. However, if the activity is a system activity, the business process engine does not assign the activity to any user and the control flows to step 506.

At step 506, one or more events are read from the external application executing the activity. The events may be read by observing any change in the state of application data generated by the external application. Examples of changes in the application data include, but are not limited to, addition of a new row in a database table, update a change of column in a database table, entries made to a log file etc. In accordance with various embodiments, the events may be read by the business process engine or by a process monitoring engine.

At step 508, the events are mapped to the monitored activity and at step 510, the monitored activity is mapped to the relevant process instance by the business process engine using a correlation identifier previously assigned to the activity by the business process engine. The business process engine subsequently updates the status of the activity.

After the business process engine updates the status of the monitored activity, control returns to step 412, where the status of the activity is displayed to the second user on a dashboard. If the activity does not meet predefined SLAs and/or KPIs, the activity may be flagged and the user may be alerted through an e-mail, SMS, paging message, instant messages, call, or an alert on the dashboard.

At step 414, the business process engine identifies whether there are any further activities pending for execution in the business process. If there are one or more activities pending for execution, control flows back to step 408 and the process continues as described earlier. However, if there are no more activities in the business process, the process ends.

Thus, using the described system and method, a process that includes multiple types of activities, such as orchestrated activities and monitored activities, may be executed. The system also enables end-to-end process visibility for both types of activities. Further, the system provides the capability of extending the process executing in a legacy system by adding new orchestrated activities. Additionally, the system provides the capability of adding allocation rules to both monitored activities and orchestrated activities. In addition to the above, using the described system and method, a process implemented in legacy systems can be redefined as a guided process where the process owner may define the order of the activities already implemented in legacy systems, add new activities to be executed by the business process engine and may remove any unimportant activities implemented in the legacy systems by not adding them to the process definition.

Exemplary Computing Environment

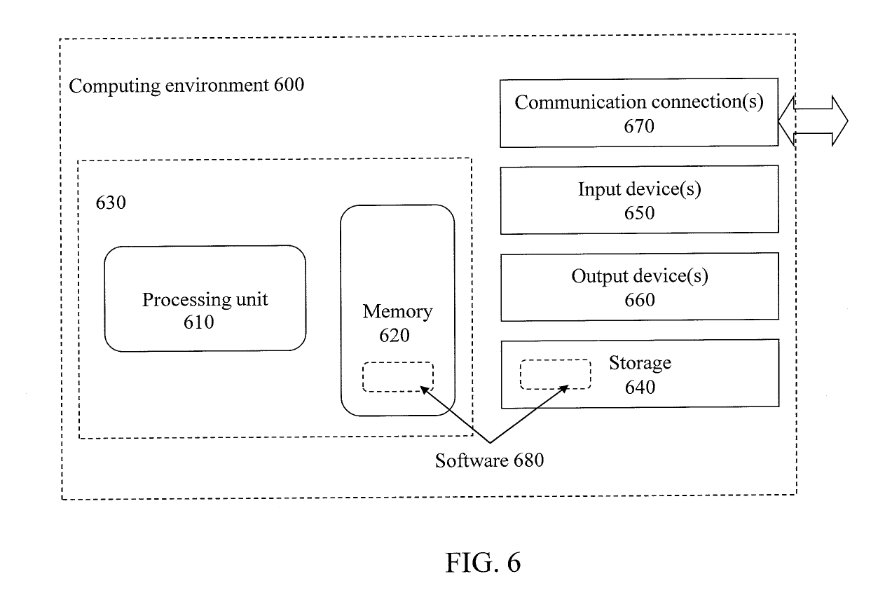

One or more of the above-described techniques can be implemented in or involve one or more computer systems. FIG. 6 illustrates a generalized example of a computing environment 600. The computing environment 600 is not intended to suggest any limitation as to scope of use or functionality of described embodiments.

With reference to FIG. 6, the computing environment 600 includes at least one processing unit 610 and memory 620. In FIG. 6, this most basic configuration 630 is included within a dashed line. The processing unit 610 executes computer-executable instructions and may be a real or a virtual processor. In a multi-processing system, multiple processing units execute computer-executable instructions to increase processing power. The memory 620 may be volatile memory (e.g., registers, cache, RAM), non-volatile memory (e.g., ROM, EEPROM, flash memory, etc.), or some combination of the two. In some embodiments, the memory 620 stores software 680 implementing described techniques.

A computing environment may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, CD-RWs, DVDs, or any other medium which can be used to store information and which can be accessed within the computing environment 600. In some embodiments, the storage 640 stores instructions for the software 680.

The input device(s) 650 may be a touch input device such as a keyboard, mouse, pen, trackball, touch screen, or game controller, a voice input device, a scanning device, a digital camera, or another device that provides input to the computing environment 600. The output device(s) 660 may be a display, printer, speaker, or another device that provides output from the computing environment 600.

The communication connection(s) 670 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 600, computer-readable media include memory 620, storage 640, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

1. A method for end-to-end process execution, comprising:
generating a model for a business process to be executed, the business process comprising a first type of activity and a second type of activity;
initiating a business process instance of the business process;
executing the first type of activity on a business process engine;
assigning the second type of activity dynamically to a first user for execution on an application external to the business process engine based on predefined factors, provided the second type of activity is a manual activity;
monitoring execution of the second type of activity by the business process engine; and
displaying status of each activity in the business process instance to a second user.

2. The method according to claim 1, wherein the step of monitoring the execution of the second type of activity by the business process engine is followed by the step of correlating the second type of activity to the business process instance.

3. The method according to claim 1, wherein the first type of activity is one of a system activity and a manual activity.

4. The method according to claim 1, wherein the second type of activity is one of a system activity and a manual activity.

5. The method according to claim 1, wherein the predefined factors comprise at least one of workload of the first user, role of the first user, and time of day.

6. The method according to claim 1, further comprising displaying a list of one or more activities pending for execution.

7. A system for end-to-end process execution, comprising:
a process modeler configured to generate a model for a business process to be executed, the business process comprising a first type of activity and a second type of activity;
a business process engine, on initiation of a business process instance, configured to:
execute the first type of activity;
assign the second type of activity dynamically to a first user for execution on an application external to the business process engine based on a set of predefined factors, provided the second type of activity is a manual activity; and
monitor execution of the second type of activity; and
a dashboard configured to display status of each activity in the business process instance to a second user.

8. The system according to claim 7, wherein the application external to the business process engine provides the execution status of the second type of activity to at least one of the business process engine and a process monitoring engine.

9. The system according to claim 8, wherein the process monitoring engine provides the execution status of the second type of activity to the business process engine.

10. The system according to claim 7, wherein the business process engine correlates the second type of activity with the business process instance based on a correlation identifier.

11. The system according to claim 7, wherein the business process engine maintains a list of activities pending for execution.

12. The system according to claim 7, wherein the predefined factors comprise at least one of workload of the first user, role of the first user, and time of day.

13. The system according to claim 7, wherein the dashboard displays alerts for one or more activities.

14. The system according to claim 7, further comprising a user portal for displaying a list of one or more activities pending for execution.

15. The system according to claim 7, wherein the first type of activity is one of a system activity and a manual activity.

16. The system according to claim 7, wherein the second type of activity is one of a system activity and a manual activity.

17. A computer program product for use with a computer, the computer program product comprising a computer usable medium having a computer readable program code embodied therein for end-to-end process execution, the computer readable program code storing a set of instructions configured for:
generating a model for a business process to be executed, the business process comprising a first type of activity and a second type of activity;
initiating a business process instance of the business process;
executing the first type of activity on a business process engine;
assigning the second type of activity dynamically to a first user for execution on an application external to the business process engine based on a set of predefined factors, provided the second type of activity is a manual activity;
monitoring execution of the second type of activity by the business process engine; and
displaying status of each activity in the business process instance to a second user.

18. The computer program product according to claim 17, wherein the first type of activity is one of a system activity and a manual activity.

19. The computer program product according to claim 17, wherein the second type of activity is one of a system activity and a manual activity.

20. The computer program product according to claim 17, wherein the predefined factors comprise at least one of workload of the user, role of the user, and time of day.
